(19) United States
(12) Patent Application Publication
(10) Pub. No.: US 2014/0093131 A1
(43) Pub. Date: Apr. 3, 2014

(54) VISIBILITY IMPROVEMENT IN BAD WEATHER USING ENCHANCED REALITY

(71) Applicant: XEROX CORPORATION, Norwalk, CT (US)

(72) Inventors: Zhigang Fan, Webster, NY (US); Hengzhou Ding, Webster, NY (US)

(73) Assignee: XEROX CORPORATION, Norwalk, CT (US)

(21) Appl. No.: 13/665,987

(22) Filed: Nov. 1, 2012

Related U.S. Application Data
(60) Provisional application No. 61/708,112, filed on Oct. 1, 2012.

(51) Int. Cl. G06K 9/68; G06K 9/00

(52) U.S. Cl. 382/104

(57) ABSTRACT

Methods and systems for improving driver visibility during bad weather and/or poor lighting for objects such as road signs, road lines, road markings, etc. The disclosed approach can enhance the captured images by exploiting priori knowledge about the scene and the objects that are stored in a database. In general, the orientation and location of a vehicle can be determined, and data can be retrieved which is indicative of stationary objects that are anticipated to be detectable at a current orientation and location of the vehicle. A captured scene is compared to data retrieved from the database using the information regarding the orientation and the location of the vehicle such that a matching scene indicates where objects are expected to appear in the captured scene and improve driver visibility with respect to the vehicle during poor driving conditions.

### CROSS-REFERENCE TO PROVISIONAL APPLICATION

This application clams priority under 35 U.S.C. 119(e) to U.S. Provisional Patent Application Ser. No. 61/708,112, entitled “Visibility Improvement in Bad Weather Using Enhanced Reality,” which was filed on Oct. 1, 2012 the disclosure of which is incorporated herein by reference in its entirety.

### TECHNICAL FIELD

Embodiments are generally related to data-processing methods and systems and processor-readable media. Embodiments are also related to visibility for automobile safety.

### BACKGROUND OF THE INVENTION

Visibility is essential for automobile safety. A major cause of vehicle accidents is reduced visibility due to bad weather conditions such as heavy rain, snow, and fog. There have been various efforts in hardware system development for improving visibility for automobiles, including high sensitive cameras for visible/invisible light, technologies that project visible/invisible light, Radar, and LIDAR. More recently, software based methods have caught more attention.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for methods and systems for improving driver visibility.

It is another aspect of the disclosed embodiments to provide for methods and systems for enhancing captured images by exploiting the priori knowledge about a scene and objects stored in a datable.

The aforementioned aspects and other objectives and advantages can now be achieved as described herein. Methods and systems are disclosed for improving driver visibility during bad weather and/or poor lighting for objects such as road signs, road lines, road markings, etc. The disclosed approach can enhance the captured images by exploiting the priori knowledge about the scene and the objects that are stored in the database.

A processing unit can determine the vehicle location and orientation from the GPS and other location/orientation sensors (e.g., magnetic sensor). The processing unit can download from a database a list of the stationary objects that are expected to be detectable at the current location and orientation. It also compares the scene captured from the camera with the one obtained from the database using the location and orientation information. The matched scenes indicate where the objects are expected to appear in the captured image. The object is then detected from the captured images at the expected location and orientation using various known technologies.

The visibility of the detected object can then be enhanced by conventional methods such as boosting object contrast, increasing object color saturation, enhancing object text readability, modifying object color, and/or reducing noise. The disclosed approach may also incorporate the information about the object that is retrieved from the database.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a system for improving driver visibility during bad weather and/or poor lighting for objects such as road signs, road lines, and road markings, in accordance with the disclosed embodiments;

FIG. 2 illustrates a high-level flow chart of operations depicting logical operational steps of a method for object detection, analysis, and processing, in accordance with the disclosed embodiments;

FIG. 3 illustrates an original image captured by a camera during a rainy morning, in accordance with the disclosed embodiments;

FIG. 4 illustrates the image of FIG. 3 after enhancement, in accordance with the disclosed embodiments;

FIG. 5 illustrates a block diagram of a data-processing system that may be utilized to implement one or more embodiments; and

FIG. 6 illustrates a computer software system for directing the operation of the data-processing system depicted in FIG. 5, in accordance with an example embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

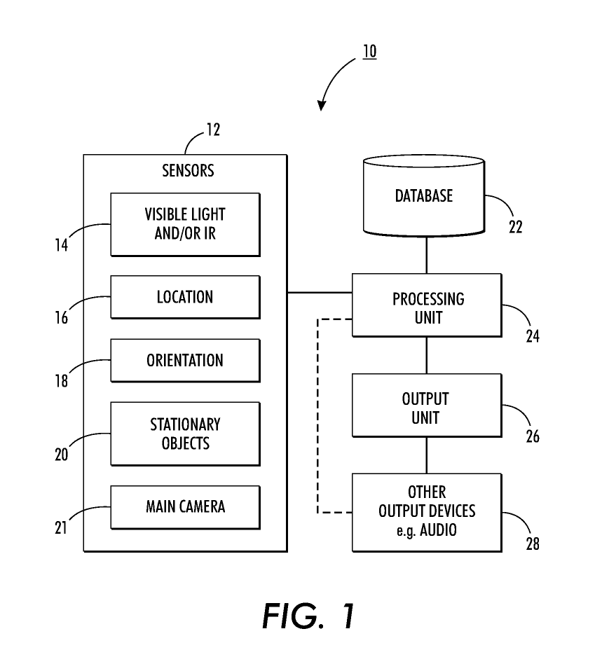

FIG. 1 illustrates a system 10 for improving driver visibility during bad weather and/or poor lighting for objects such as road signs, road lines, road markings, etc., in accordance with the disclosed embodiments. System 10 generally includes a group of sensors 12 (including at least one camera) that can communicate with a processor or processing unit 24, which in turn can communicate with an output unit 26 and/or other output devices 28 (e.g, audio). The processing unit 24 can also communicate with a database 22 that stores data indicative of objects. Such an approach can enhance captured images by exploiting the priori knowledge about the scene and objects that are stored in the database 22.

The system 10 is generally composed of: 1) the set of sensors (including at least one camera) 21 that capture images, determines a vehicle location and orientation, and detects various stationary objects; 2) the database 22 that contains information about the objects such as road signs, road lines, and road markings, as well as road scenes; 3) the processing unit 24, which analyzes and processes the information provided by the sensors 12 and the database 22, and enhances the image/video captured; and 4) an output unit 26 which contains at least a display screen. Such a system 10 may also include other output devices 28 such as audio outputs.

The sensors 12 employed in system 10 can be divided into three groups: (visible light and/or infrared (IR)) video cameras 14; location sensors 16 and/or orientation sensors 18; and object detection sensors 20. System 10 can include at least one main camera 21 that captures scenes. The main camera 21 can work with, for example, visible light or IR. Such a system 10 such as those provided by one or more of the sensing devices 14 can contain additional IR cameras, particularly if the main camera 21 relies on visible light. The IR cameras may cover multiple frequency bands for better object detection and classification.

A GPS or a similar device may be applied for location determination of the vehicle. The location sensing device 16 may, for example, be implemented in the context of a GPS device/sensor. Furthermore, orientation of the vehicle can also be obtained from the GPS by detecting its trajectory. The orientation sensing device 18 may also be implemented in the context of a GPS device or with GPS components. In this manner, the locating and orientation sensing devices 16, 18 may be implemented as or with a single GPS module or component, depending upon design considerations. Alternatively, orientation can also be found using a dedicated orientation sensor such as a magnetic sensor. Finally, various sensors such as radars, LIDARs, and other devices that project light are useful for detecting objects and determining their 3-D locations and shapes.

The database 22 can contain data indicative of, for example, the road scene, which is mainly viewed from a driver facing the forward direction. Database 22 can also contain data indicative of attributes about stationary objects such as road signs, road lines, road markings, and so forth. The attributes of an object may include its location (in 3-D), size, shape, color, material property (metal, wood, etc.), the text contained, etc.

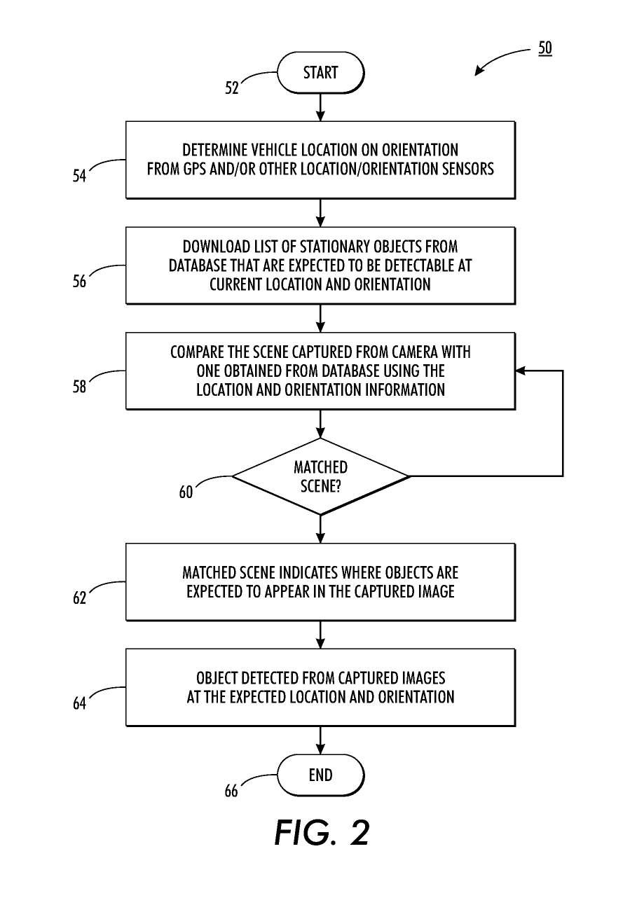

FIG. 2 illustrates a high-level flow chart of operations depicting logical operational steps of a method 50 for object detection, analysis, and processing, in accordance with the disclosed embodiments. The process can begin as shown at block 52. As indicated at block 54, the processing unit 24 can initially determine location and orientation of the vehicle from data provided by, for example, a GPS or other location/orientation sensors 16, 18 depicted in FIG. 1. The processing unit 24 can then download from the database 22 shown in FIG. 1 a list of the stationary objects that are expected to be detectable at the current location and orientation, as illustrated at block 56. Therafter, as indicated at block 58, processing unit 24 can also compare the scene captured from the camera with the one obtained from the database 22 utilizing the location and orientation information. Following processing of the operation indicated at block 58, a test can be performed as illustrated at block 60, to determine if scenes are matched. If not, then the operation shown at block 58 can be repreated. If so, then as described at block 62, the matched scenes indicate where the objects are expected to appear in the captured image. The object can then be detected as depicted at block 64 from the captured images at the expected location and orientation using various known technologies such as pattern matching, Scale-Invariant Feature Transform (SIFT), and Histogram of Oriented Gradients (HOG). The process can then terminate, as illustrated at block 66.

The detection reliability and accuracy can further be improved by incorporating information captured by various object detection sensors such as sensor(s) 12 shown in FIG. 1. For example, if a road sign is predicted by the database 22 to exist at certain 3-D location and if it is detected by both the camera and another device (say a LIDAR) at the same spot, the detection is very likely to be accurate. On the other hand, if the LIDAR finds the sign at a different location, the implication would be one or more components in the system made an error.

The visibility of the detected object can be enhanced by conventional methods such as boosting object contrast, increasing object color saturation, enhancing object text readability, modifying object color, and/or reducing noise. It may also incorporate the information about the object that is retrieved from the database by:

Mixing: The prior information can be combined with the captured scene in a weighted fashion. For example, a STOP sign in a captured image may have a faded red background and a darkened white text. To improve the visibility, the saturation of the red color will be enhanced and the white color will be brightened when the captured image is combined with the colors specified in the database 22 for the sign. The relative weighting depends on the confidence level of the detection accuracy, the confidence level of database accuracy, and the weather condition. For example, under optimal weather conditions, the captured image may be displayed via output unit 26 without alternations. Under bad weather conditions, however, increased reliance on database 22 may be required, particularly if the detection is confirmed by multiple sensors 12. The weighting may also be user-adjustable so that a user may select the tradeoff that best fits to his/her preference.

Insertion: It is possible to insert information that is not currently visible, but existing in the database 22. This can be considered as an extreme case for mixing. This happens, for example, during a day of heavy fog, a plate carrying a road sign is detected by a radar device and its location and shape match the information stored in the database. A synthetic road sign may be added into the scene for display.

Guided filtering: Snow and rain noise can often be effectively reduced by temporal and/or spatial filtering. However, conventional filtering may also lead to blurred scene and lost details. Applying the location and shape information of the objects, effective edge-preserving can be implemented, which removes the noise while maintaining the detail fidelity.

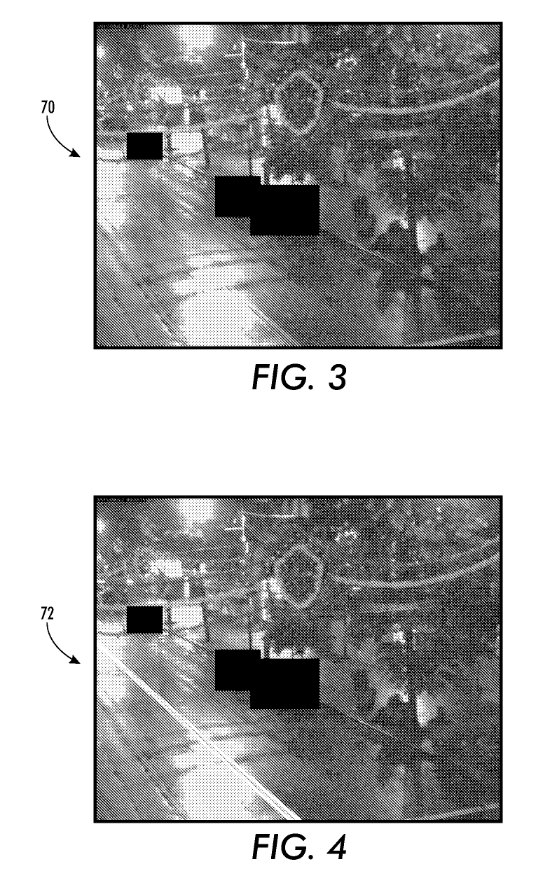

FIG. 3 illustrates an original image 70 captured by a camera during a rainy morning, in accordance with the disclosed embodiments. FIG. 4 illustrates an image 72 indicative of the image 70 of FIG. 3 after enhancement, in accordance with the disclosed embodiments, The image 70 shown in FIG. 3 is, for example, the original image captured by a camera (e.g., main camera 21) during a rainy morning. The road line is barely visible due to the poor lighting conditions, particularly at the segments where strong reflectance exists, The image 72 of FIG. 4 illustrates the result after the enhancement. The road line becomes clearly visible. The vehicles in both images were blacked-out for protecting privacy.

Note that the disclosed embodiments are described herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

As will be appreciated by one skilled in the art, the disclosed embodiments can be implemented as a method, data-processing system, or computer program product. For example, the process flow or method described above can be implemented in the context of a data-processing system, computer program, processor-readable media, etc.

Accordingly, the embodiments may take the form of an entire hardware implementation, an entire software embodiment or an embodiment combining software and hardware aspects all generally referred to as a “circuit” or “module.” Furthermore, the disclosed approach may take the form of a computer program product on a computer-usable storage medium having computer-usable program code embodied in the medium, Any suitable computer readable medium may be utilized including hard disks, USB flash drives, DVDs, CD-ROMs, optical storage devices, magnetic storage devices, etc.

Computer program code for carrying out operations of the present invention may be written in an object oriented programming language (e.g., JAVA, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, WiMax, 802.11x, and cellular network or the connection can be made to an external computer via most third party supported networks (e.g., through the Internet via an internet service provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data-processing apparatus to produce a machine such that the instructions, which execute via the processor of the computer or other programmable data-processing apparatus, create means for implementing the functions/acts specified with respect to, for example, the various instructions of the process/flow or method described above.

These computer program instructions may also be stored in a computer-readable memory that can direct a computer or other programmable data-processing apparatus to function in a particular manner such that the instructions stored in the computer-readable memory produce an article of manufacture including instruction means which implement the function/act specified in, for example, a block or blocks of a process flow diagram or flow chart of logical operations.

The computer program instructions may also be loaded onto a computer or other programmable data-processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

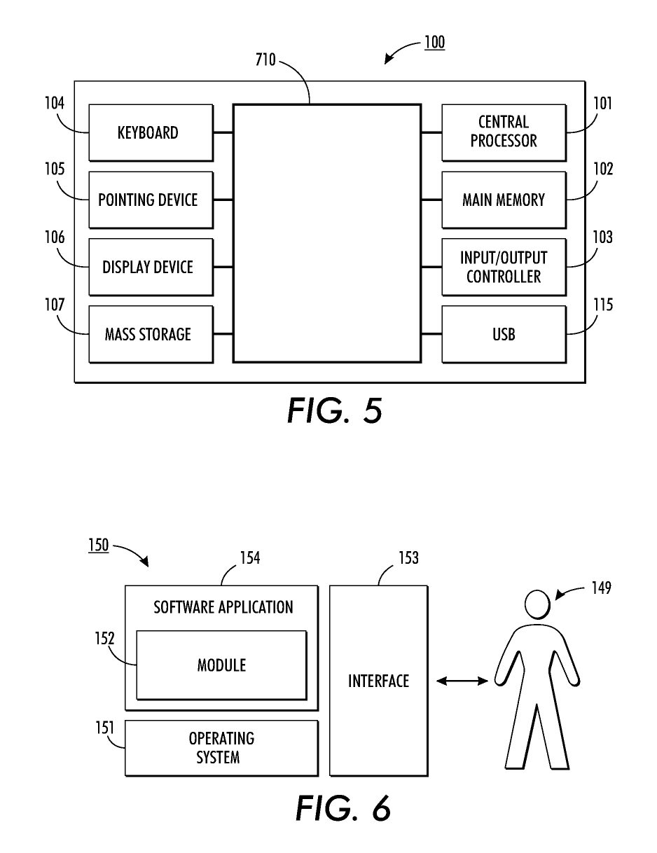

FIG. 5-6 are provided as exemplary diagrams of data-processing environments in which embodiments of the present invention may be implemented. It should be appreciated that FIGS. 5-6 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments,

As illustrated in FIG. 5, the disclosed embodiments may be implemented in the context of a data-processing system 100 that includes, for example, a central processor 101 (or other processors), a main memory 102, an input/output controller 103, and in some embodiments, a USB (Universal Serial Bus) 115 or other appropriate peripheral connection. System 100 can also include a keyboard 104, an input device 105 (e.g., a pointing device such as a mouse, track ball, pen device, etc.), a display device 106, and a mass storage 107 (e.g., a hard disk). As illustrated, the various components of data-processing system 100 can communicate electronically through a system bus 710 or similar architecture. The system bus 710 may be, for example, a subsystem that transfers data between, for example, computer components within data-processing system 100 or to and from other data-processing devices, components, computers, etc.

FIG. 6 illustrates a computer software system 150, which may be employed for directing the operation of the data-processing system 100 depicted in FIG. 5. In general, computer software system 150 can include an interface 152, an operating system 151 a software application 154 and one or more modules, such as module 152. Software application 154, stored in main memory 102 and on mass storage 107 shown in FIG. 5, generally includes and/or is associated with a kernel or operating system 151 and a shell or interface 153. One or more application programs, such as module(s) 152, may be “loaded” (i.e., transferred from mass storage 107 into the main memory 102) for execution by the data-processing system 100. The data-processing system 100 can receive user commands and data through user interface 153 accessible by a user 149. These inputs may then be acted upon by the data-processing system 100 in accordance with instructions from operating system 151 and/or software application 154 and any software module(s) 152 thereof.

The following discussion is intended to provide a brief, general description of suitable computing environments in which the system and method may be implemented, Although not required, the disclosed embodiments will be described in the general context of computer-executable instructions, such as program modules, being executed by a single computer. In most instances, a “module” constitutes a software application.

Generally, program modules (e.g., module 152) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like,

Note that the term module as utilized herein may refer to a collection of routines and data structures that perform a particular task or Implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

The interface 153 (e.g., a graphical user interface) can serve to display results, whereupon a user may supply additional inputs or terminate a particular session. In some embodiments, operating system 151 and interface 153 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 151 and interface 153. The software application 154 can include, for example, module(s) 152, which can include instructions for carrying out steps or logical operations such as those of method 50 and other process steps described herein.

FIG. 5-6 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, Unix, Linux, and the like.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for improving driver visibility during poor driving conditions, said method comprising:
determining an orientation and a location of a vehicle;
retrieving data indicative of stationary objects that are anticipated to be detectable at a current orientation and location of said vehicle; and
comparing a captured scene with said data retrieved from said database using said information regarding said orientation and said location of said vehicle such that a matching scene thereof indicates where objects are expected to appear in said captured scene to generate at least one detected object and improve driver visibility with respect to said vehicle during poor driving conditions.

2. The method of claim 1 wherein retrieving data indicative of stationary objects that are anticipated to be detectable at a current orientation and location of said vehicle, further comprises retrieving said data from a database.

3. The method of claim 1 wherein retrieving data indicative of stationary objects that are anticipated to be detectable at a current orientation and location of said vehicle, further comprises downloading said data from said database.

4. The method of claim 1 wherein determining an orientation and a location of a vehicle, further comprises determining said orientation and said location of said vehicle utilizing at least one GPS sensor.

5. The method of claim 1 further comprising enhancing a visibility of said at least one detected object by at least one of:
boosting object contrast with respect to said at least one detected object;
increasing object color saturation with respect to said at least one detected object;
enhancing object text readability with respect to said at least one detected object;
modifying at least one color associated with said at least one detected object; and
reducing noise.

6. The method of claim 1 displaying enhanced images with respect to said at least one detected object.

7. The method of claim 6 wherein said enhanced images are displayable via a display associated with a dashboard of said vehicle.

8. The method of claim 6 wherein said enhanced images are displayable via special goggles that electronically display images.

9. A system for improving driver visibility during poor driving conditions, said system comprising:
a processor;
a data bus coupled to said processor; and
a computer-usable medium embodying computer program code, said computer-usable medium being coupled to said data bus, said computer program code comprising instructions executable by said processor and configured for:
determining an orientation and a location of a vehicle;
retrieving data indicative of stationary objects that are anticipated to be detectable at a current orientation and location of said vehicle; and
comparing a captured scene with said data retrieved from said database using said information regarding said orientation and said location of said vehicle, such that a matching scene thereof indicates where objects are expected to appear in said captured scene to generate at least one detected object and improve driver visibility with respect to said vehicle during poor driving conditions.

10. The system of claim 9 wherein said instructions for retrieving data indicative of stationary objects that are anticipated to be detectable at a current orientation and location of said vehicle, further comprise instructions for retrieving said data from a database.

11. The system of claim 9 wherein said instructions for retrieving data indicative of stationary objects that are anticipated to be detectable at a current orientation and location of said vehicle, further comprise instructions for downloading said data from said database.

12. The system of claim 11 wherein said instructions for determining an orientation and a location of a vehicle, further comprise instructions for determining said orientation and said location of said vehicle utilizing at least one GPS sensor.

13. The system of claim 11 wherein said instructions are further configured for enhancing a visibility of said at least one detected object by at least one of:
boosting object contrast with respect to said at least one detected object;
increasing object color saturation with respect to said at least one detected object;
enhancing object text readability with respect to said at least one detected object;
modifying at least one color associated with said at least one detected object; and
reducing noise.

14. The system of claim 11 wherein said instructions are further configured for displaying enhanced images with respect to said at least one detected object.

15. The system of claim 14 wherein said enhanced images are displayable via a display associated with a dashboard of said vehicle.

16. The system of claim 15 wherein said enhanced images are displayable via special goggles that electronically display images.

17. A processor-readable medium storing code representing instructions to cause a process to improve driver visibility during poor driving conditions, said code comprising code to:
determine an orientation and a location of a vehicle;
retrieve data indicative of stationary objects that are anticipated to be detectable at a current orientation and location of said vehicle; and
compare a captured scene with said data retrieved from said database using said information regarding said orientation and said location of said vehicle such that a matching scene thereof indicates where objects are expected to appear in said captured scene to generate at least one detected object and improve driver visibility with respect to said vehicle during poor driving conditions.

18. The process-readable medium of claim 17 wherein said code to retrieve data indicative of stationary objects that are anticipated to be detectable at a current orientation and location of said vehicle, further comprises code to retrieve said data from a database.

19. The process-readable medium of claim 17 wherein said code to retrieve data indicative of stationary objects that are anticipated to be detectable at a current orientation and location of said vehicle, further comprises code to download said data from said database.

20. The process-readable medium of claim 17 wherein said code to determine an orientation and a location of a vehicle, further comprises code to determine said orientation and said location of said vehicle utilizing at least one GPS sensor.
